(19) United States
(12) Patent Application Publication
(10) Pub. No.: US 2010/0014857 A1
(43) Pub. Date: Jan. 21, 2010

(54) Method of mapping OPUke into OTN frames

(75) Inventor: Wally Haas, Mount Pearl (CA)

Correspondence Address: AVALON MICROELECTRONICS, INC.;ATTN: Intellectual Property, 58 Glencoe Drive, Mount Pearl, NF, A1N 4S9, CA

(73) Assignee: Avalon Microelectronics, Inc., Mount Pearl (CA)

(21) Appl. No.: 12/174,821

(22) Filed: Jul. 17, 2008

(51) Int. Cl. H04J 14/00

(52) U.S. Cl. 398/43

(57) ABSTRACT

The present invention discloses a method of mapping Optical Payload Unit (OPU) k (k=1, 2, 3 or any positive integer) Ethernet signals (E) into Optical Transport Network (OTN) frames for 10 Gigabit Ethernet (10 GbE) Local Area Network Physical Layer (LAN PHY), wherein OPUk Overhead (OH) is altered by the relocation of Justification Control (JC) bytes, from the standardized ITU-T G.709 locations, into the novel locations of rows 1-3 of column 15. This allows for rows 1-4 of column 16 to be available for any type of Justification Overhead (JOH), such as four Negative Justification Opportunity (NJO) byte locations. Four NJO byte locations, combined with four Positive Justification Opportunity (PJO) byte locations in rows 1-4 of column 17, provides for up to nine justification state choices to be determined by the JC bytes. In addition, the ability to add or remove a plurality of two, three or fours bytes from OTN Payload can double, triple, or quadruple the standardized maximum bit rate tolerance of ±65 parts per million (ppm).

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Technical Field of the Invention

The present invention relates to the mapping of OPUke into OTN frames for 10 GbE LAN PHY.

2. Background of the Invention

The International Telecommunication Union, Telecommunication Standardization Sector (ITU-T) Recommendation G.709, “Interfaces for the optical transport network (OTN),” defines the Optical Transport Network (OTN) frame as consisting of three main sections; the 16 byte overhead (OH) section; the 3808 byte payload (PL) section; and the 256 byte forward error correction (FEC) section (FIG. 1). OTN is able to transport via three standard rates, Optical Data Unit (ODU) k, where k=1, 2 or 3.

The 16 byte OH section is comprised of the OH Frame Alignment Signal (FAS), the Optical Transport Unit (OTU) OH, the Optical Data Unit (ODU) OH and the Optical Payload Unit (OPU) OH (FIG. 2). The FAS is located in row 1, columns 1-7 of the OTN frame, and includes the Multi-Frame Alignment Signal (MFAS). The OTU OH is located in row 1, columns 8-14, and is responsible for Section Monitoring (SM) and General Communication Channel 0 (GCC0) and row 1 of columns 13-14 contains bytes reserved for future international standardization (RES). The ODUk OH is located in rows 2-4, columns 1-14, and is responsible for Path Monitoring (PM), Tandem Connection Monitoring (TCM), General Communications Channels 1 and 2 (GCC1/GCC2), ODUk Automatic Protection Switching and Protection Communication Channel (APS/PCC), Fault Type and Fault Location Reporting Communication Channel (FTFL), ODUk Experimental Overhead (EXP) and additional ODUk OH bytes reserved for future international standardization (RES), these reserved OH bytes being located in row 2, columns 1-3, and row 4, columns 9-14.

The OPUk area is organized in an octet based block frame structure with 4 rows and 3810 columns; it consists of the OPUk OH, located in rows 1-4 of columns 15-16, and the OPUk Payload, located in rows 1-4 of columns 17-3824 (FIG. 3). The bytes contained in the OPUk OH are dedicated to mapping and concatenation. The OPUk OH includes bytes reserved for future international standardization (RES) which can be found in rows 1-3 of column 15, followed by the Payload Structure Identifier (PSI), located in row 4 of column 15. The PSI is a 256 byte signal containing the Payload Type (PT) in the first byte, followed by 255 bytes reserved for future international standardization (RES) (FIG. 5). The OPUk OH also includes means for justification, such as the Justification Control (JC) bytes in rows 1-3, column 16, the Negative Justification Opportunity (NJO) byte in row 4 of column 16, and the Positive Justification Opportunity (PJO) byte, which is stored with the OPUk PL in row 4 of column 17. Each JC byte is comprised of eight bits; bits 1-6 are reserved for future international standardization (RES) and bits 7-8 are used for justification control (FIG. 4). As standardized, the JC bits 7-8 control the Negative Justification Opportunity (NJO) byte and Positive Justification Opportunity (NJO) byte which follow in row 4, columns 16-17, respectively.

During asynchronous mapping, the digitally wrapped client line signal rate and the PL signal rate are not equal. Such signal frequency differences can be accommodated by a justification mechanism, such as the mapping and concatenation means found in the OPUk OH. Asynchronous and bit synchronous mapping generates the JC bytes, NJO bytes and PJO bytes, while demapping interprets the JC bytes, NJO bytes and PJO bytes. A per-frame justification counter employs a majority vote process (two out of three JC bytes) to make a justification decision during demapping to prevent JC signal errors. The majority vote is communicated through bits 7-8 of the JC byte, using the binary 00, 01, 10-11. As standardized in ITU-T G.709, when interpreting the NJO byte during asynchronous mapping, JC 00 indicates a justification byte, JC 01 indicates a data byte, JC 10 is not generated and JC 11 indicates a justification byte. When interpreting the PJO byte during asynchronous mapping, JC 00 indicates a data byte, JC 01 indicates a data byte, JC 10 is not generated and JC 11 indicates a justification byte. Likewise, when interpreting the NJO byte during demapping, JC 00 indicates a justification byte, JC 01 indicates a data byte, JC 10 indicates a justification byte and JC 11 indicates a justification byte. When interpreting the PJO byte during demapping, JC 00 indicates a data byte, JC 01 indicates a data byte, JC 10 indicates a data byte and JC 11 indicates a justification byte. If the majority vote is for negative justification, then data can be subtracted, if necessary, and if the majority vote is for positive justification then data can be added, if necessary. The asynchronous mapping of the OPUk signal is created from a locally generated clock, independent of the client signal. Because only one byte per frame can be justified, there is a maximum clock frequency difference, so despite the addition or subtraction of a justification byte or a data byte, the PL is allowed to be amiss by a certain frequency difference. As standardized in ITU-T G.709, asynchronous mapping of the OPUk signal generated from the local clock employs a 4^{(k-1)}×2488320 kbit/s (k=1, 2 or 3) signal mapped to the OPUk using a positive, negative or zero justification scheme.

In the case of a client signal failure, the failed 2.5 Gb, 10 Gb or 40 Gb client signal is replaced by an Alarm-Indication-Signal (AIS) and is then mapped into the OPUk. In the case of an incoming ODUk/OPUk signal failure, the 2.5 Gb, 10 Gb or 40 Gb client signal is again replaced by an Alarm-Indication-Signal (AIS), and is then mapped into the OPUk.

ITU-T Supplement 43, “Transport of IEEE 10 G Base-R in Optical Transport Networks (OTN)” outlines schemes for non-standardized mappings, such as Bit Transparent Mapping of 10 Gb Base-R Signal into OPU1e and Bit Transparent Mapping of 10 Gb Base-R Signal into OPU2e. When mapping 10 Gb into OPUke, the maximum bit rate tolerance between OPUke and the client signal clock, as standardized by ITU-T G.709, is ±65 ppm. With the bit rate tolerance for the OPUke clock at ±20 ppm, the client signal's bit rate tolerance can be ±45 ppm.

As standard, when mapping 10 Gigabit Ethernet (10 GbE) into OPUke, groups of eight successive bits (not necessarily a byte) of the 10 GbE signal are mapped into a data byte of the OPUke. Once per OPUke frame, a positive or negative justification action may be performed. When the clock tolerance of the underlying Ethernet signal is ±100 ppm, rather than the standard ±20 ppm, standard methods of control of jitter and wander to not apply; the line rate must be non-standard to accommodate a ±100 ppm underlying Ethernet signal with adequate justification capability.

Similarly, when mapping 10 GbE into OPU2e, groups of eight successive bits (not necessarily a byte) of the 10 GbE signal are mapped into a data byte of the OPU2e. However, 64 fixed stuff (FS) bytes are added in columns 1905-1920. Once per OPU2e frame, a positive or negative justification action may be performed. As suggested in ITU-T Supplement 43, a client signal, or 10 GbE Local Area Network Physical Layer (LAN PHY) with fixed stuff bytes is adapted into an OPU-like signal, further into an ODU-like signal, then finally into an OTU-like signal (OPU2, ODU2, and OTU2, respectively). With this mapping, the OTU2 signal must be clocked at a nominal bit rate of 11.0957 Gbit/s, as opposed to the standard OTU2 nominal bit rate of 10.709225316 Gbit/s. The signal is formed by wrapping a signal with the clock tolerance of the underlying Ethernet signal of ±100 ppm, rather than the standard OTU2 signal of ±20 ppm. The 10 GbE LAN PHY does not transmit the timing of synchronization information, so bit stuffing is not necessary. The OPU OH bytes dedicated to mapping and concatenation are used to carry the necessary data.

It is known in the art to wrap an OTN frame around the 10 GbE signal inside the PL to transfer the 10 GbE LAN PHY through the system. However, because the 10 GbE LAN PHY has a ±100 ppm capability, if the signal was wrapped during multiplexing, the ±100 ppm cannot be terminated, as the maximum bit rate tolerance capability is set at ±65 ppm, resulting in a system failure. In addition, prior art has also been known to move the location of the PSI byte from its standard column 15, row 4 location, to a new location within column 15, which can allow for additional Justification OH bytes and therefore greater justification ability, while maintaining the standardized justification utility within each individual frame.

### SUMMARY OF THE INVENTION

The present invention discloses a method of mapping Optical Payload Unit (OPU) k (k=1, 2, 3 or any positive integer) Ethernet signals (E) into Optical Transport Network (OTN) frames while increasing the Constant Bit Rate (CBR) for 10 Gigabit Ethernet (10 GbE) Local Area Network Physical Layer (LAN PHY) to at least ±100 parts per million (ppm), where only ±65 ppm is allowed and ±20 ppm is standardized as per ITU-T G.709.

The present invention addresses the shortcomings of the abovementioned prior art, and offers a novel approach to mapping OPUkE into OTN for 10 GbE LAN PHY.

### DESCRIPTION OF THE DRAWINGS

FIG. 1 is a block diagram of the Optical Transport Network (OTN) frame, as known in the art.

FIG. 2 is a block diagram of the Optical Transport Network (OTN) frame Overhead (OH), as known in the art.

FIG. 3 is a block diagram of the Optical Transport Network (OTN) frame Overhead (OH) and Payload (PL), as known in the art.

FIG. 4 is a block diagram of the standardized Justification Control (JC) byte, as known in the art.

FIG. 5 is a block diagram of the standardized Payload Structure Identifier (PSI) byte, as known in the art.

FIG. 6 is a block diagram of the Optical Transport Network (OTN) frame Overhead (OH), as disclosed in the present invention.

FIG. 7 is a block diagram depicting two frames of Optical Transport Network (OTN) frame Overhead (OH), as disclosed in the present invention.

FIG. 8 is a block diagram of one possible modification of the Justification Control (JC) byte, as disclosed in the present invention.

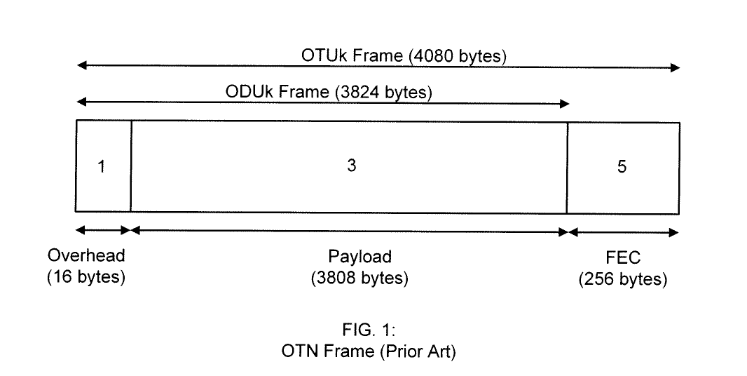

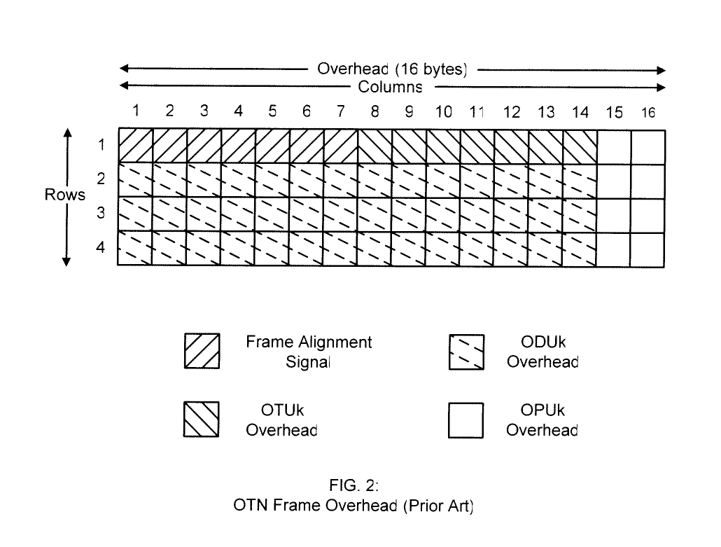

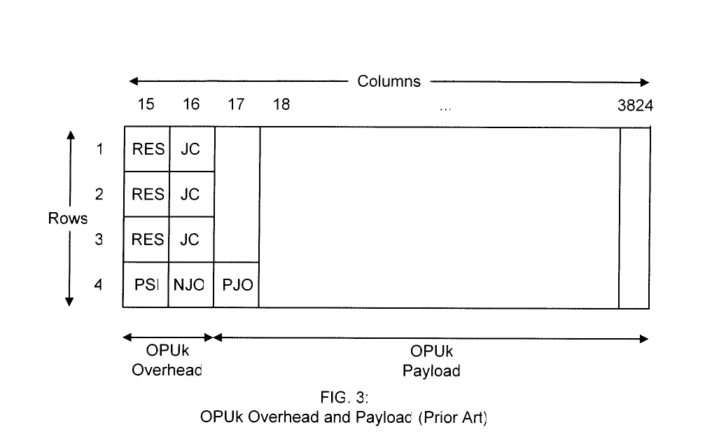

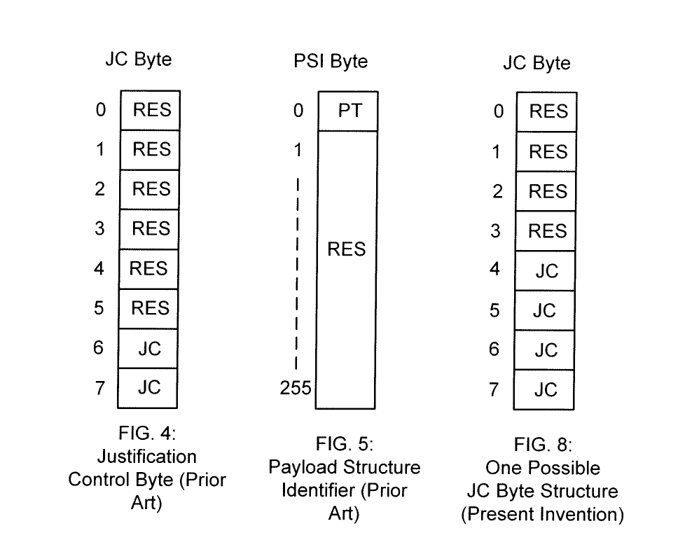

### DETAILED DESCRIPTION OF AN ILLUSTRATIVE EMBODIMENT OF THE INVENTION

The present invention discloses a method of mapping Optical Payload Unit (OPU) k (k=1, 2, 3 or any positive integer) Ethernet signals (E) into Optical Transport Network (OTN) frames while increasing the Constant Bit Rate (CBR) for 10 Gigabit Ethernet (10 GbE) Local Area Network Physical Layer (LAN PHY). As specified by ITU-T G.709, the OPUk Overhead (OH) includes: bytes reserved for future international standardization (RES) in rows 1-3, column 15; the Payload Structure Identifier (PSI), located in row 4, column 15; Justification Control (JC) bytes in rows 1-3, column 16; the Negative Justification Opportunity (NJO) byte in row 4, column 16; and the Positive Justification Opportunity in row 4, column 17.

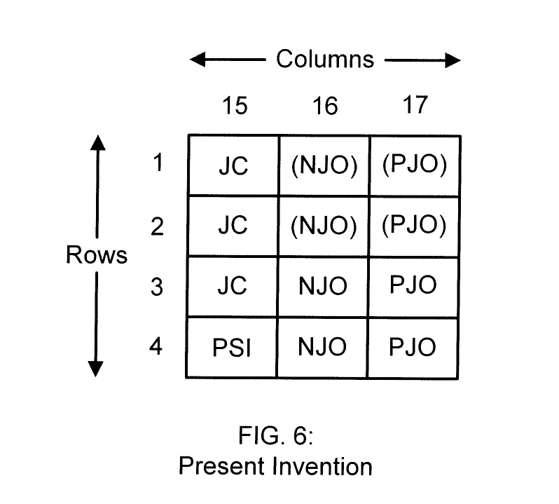

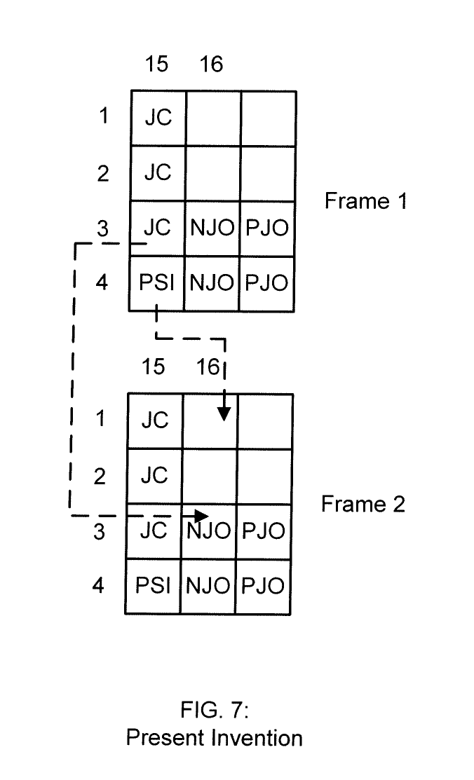

In an illustrative embodiment of the present invention, such Justification OH (JOH) bytes are relocated within the OPUk frame. As disclosed in FIG. 6, the present invention relocates the three JC bytes from their standardized locations in rows 1-3, column 16, into the RES locations of rows 1-3, column 15. This relocation of the JC bytes into column 15 leaves all four locations of rows 1-4, column 16, available for any kind of justification purposes, such as four locations of NJO bytes. However, as standardized, during the demapping process a per-frame justification counter employs a majority vote process (at least two out of three JC bytes) to make a justification decision to prevent JC signal errors. The JC bytes determine through this majority vote process what, if any, justification action needs to be taken by the NJO bytes and PJO bytes. By moving the JC bytes into column 15, rows 1-3, the ability to provide the majority vote decision from the JC bytes to the NJO byte(s) or PJO byte(s) is altered, so, as shown in FIG. 7, the JC bytes in one frame provide the majority vote decision to the NJO byte(s) or PJO byte(s) within the next frame. Because the bits are transmitted row by row, from left to right, and all the JC bytes are needed to make the majority vote, shifting the majority vote decision to one frame to the subsequent frame maintains the opportunity to provide the appropriate justification.

The present invention also improves the structure of the JC bytes and their subsequent justification control voting scheme, in addition to their location within the OPUk frame. The standardized JC byte is comprised of eight bits, with bits 1-6 as RES bits and bits 7-8 as dedicated JC bits. The standardized justification control voting scheme is based upon the JC byte containing only these two JC bits. If we let x=NJO and y=PJO, we have:

JC=00=>x=NJO=justification

JC=00=>y=PJO=data

JC=01=>x=NJO=data

JC=01=>y=PJO=data

JC=11=>x=NJO=justification

JC=11=>y=PJO=justification

In this justification control voting scheme, when bits 7-8 of the JC byte read: 00 the justification is normal; 01 the justification is negative; and 11 the justification is positive. The JC 10 byte is not generated. Therefore, as standardized, the two JC bits within the JC byte provide three different justification choices.

The present invention improves upon this standardized justification control voting scheme by first improving upon the structure of the JC bytes. The present invention modifies the structure of the JC byte, allocating any four bits for RES purposes, and any four bits as dedicated JC bits (FIG. 8 is provided as an example, with bits 1-4 as RES bits and bits 5-8 as JC bits). Therefore, we now have four separate JC bit opportunities, instead of the standardized two JC bit opportunities. With NJO bytes occupying column 16, rows 1-4, and PJO bytes occupying column 17, rows 1-4, we now have the ability to perform nine different justification choices, instead of the standardized three different justification choices. These nine justification choices, determined by the JC bytes, are: 0=normal; 1=NJO1; 2=NJO1, NJO2; 3=NJO1, NJO2, NJO3; 4=NJO1, NJO2, NJO3, NJO4; 5=PJO1; 6=PJO1, PJO2; 7=PJO1, PJO2, PJO3; and 8=PJO1, PJO2, PJO3, PJO4. Any justification choices beyond 1-8 are undefined. It should be noted that while the illustrative embodiment of the present invention assigns the justification choices in the above order, these states can be assigned in a plurality of different arrangements. When justification is normal, no action is necessary. When a negative justification choice occurs (the abovementioned choices 1-4), the client PL signal rate is faster than the line rate, necessitating the insertion of a stuff byte(s) into the frame. When a positive justification choice occurs (the abovementioned choices 5-8), the line rate is faster than the client PL signal rate, necessitating the removal of a byte(s) from the frame.

The OTN PL comprises 4 rows of 3808 bytes, for a total of 15232 bytes. With the ability to add or remove a byte, the PL becomes 1/15232, which has the standardized maximum bit rate tolerance of ±65 ppm, where:

1/15232×1⁶=±65.65 ppm

However, as the illustrative embodiment of the present invention has four locations of NJO bytes in column 16 and four locations of PJO bytes in column 17, the present invention is able to double, triple, and quadruple the standardized bit rate tolerance. Through using the additional NJO bytes and PJO bytes, the illustrative embodiment of the present invention can achieve the following maximum bit rate tolerances:

2/15232×1⁶=±131.3 ppm

3/15232×1⁶=±196.95 ppm

4/15232×1⁶=±262.6 ppm

Therefore, the relocation of the JC bytes into column 15, rows 1-4, where the JC bytes of one frame affect the NJO bytes and PJO bytes of the next frame, allow for the use of four rows of NJO bytes in column 16 and four rows of PJO bytes in column 17 providing the present invention with up to quadruple the maximum bit rate tolerance between OPUke and the client signal clock standardized by ITU-T Recommendation G.709.

1. A method of mapping a payload signal(s) (PL) into Optical Payload Unit (OPU) k (where k is a transmission rate of 1, 2, 3 or any positive integer), comprising the steps of: relocating any of a plurality of Justification Control (JC) byte(s) from the standardized ITU-T G.709 location(s) into any of a plurality of a novel location(s) of row(s) 1-3 of column 15; allowing any of a plurality of location(s) of row(s) 1-4 of column 16 to be available for any of a type of Justification Overhead (JOH) byte(s); allowing any of a plurality of location(s) of row(s) 1-4 of column 17 to be available for any of a type of Justification Overhead (JOH) byte(s); whereby said plurality of location(s) of row(s) 1-4 of column 16 and said plurality of location(s) of row(s) 1-4 of column 17 can together provide a plurality of Justification Overhead (JOH) justification state choice(s).

2. The method of claim 1, wherein said type of Justification Overhead (JOH) byte(s) for said plurality of location(s) of row(s) 1-4 of column 16 is dedicated to at least one of a Negative Justification Opportunity (NJO) byte(s).

3. The method of claim 1, wherein said type of Justification Overhead (JOH) byte(s) for said plurality of location(s) of row(s) 1-4 of column 17 is dedicated to at least one of a Positive Justification Opportunity (PJO) byte(s).

4. The method of claim 1, wherein said plurality of Justification Overhead (JOH) justification state choices comprises: a normal, and therefore no-action, justification state choice; a plurality of up to 4 of said Negative Justification Opportunity (NJO) byte(s) for at least one of a negative justification state choice(s); and a plurality of up to 4 of said Positive Justification Opportunity (PJO) byte(s) for at least one of a positive justification state choice(s).

5. The method of claim 1, wherein the relocation of said plurality of Justification Control (JC) byte(s) into said novel location(s) of row(s) 1-3 of column 15 allows said Justification Control (JC) byte(s) to provide a majority vote justification decision from said Justification Control (JC) byte(s) of a frame, to any of a amount of said Negative Justification Opportunity (NJO) byte(s) located in a subsequent frame or any of a amount of said Positive Justification Opportunity (PJO) byte(s) located in said subsequent frame.

6. A method of constructing a Justification Control (JC) byte, wherein the bit structure of said Justification Control (JC) byte is altered from the standardized ITU-T G.709 bit structure by a novel bit allocation, wherein said Justification Control (JC) byte comprises any of a amount of bits dedicated to Justification Control (JC) bit purposes and any of a amount of bits dedicated to bits reserved for future international standardization (RES) purposes.

7. The method of claim 6, wherein said novel bit allocation comprises 4 bits dedicated to Justification Control (JC) bit purposes and 4 bits dedicated to bits reserved for future international standardization (RES) purposes.

8. The method of claim 1, wherein any of said plurality of Justification Control (JC) byte(s) is altered from the standardized ITU-T G.709 Justification Control (JC) byte by a novel bit allocation, wherein any of said plurality of Justification Control (JC) byte(s) comprises any of a amount of bits dedicated to Justification Control (JC) bit purposes and any of a amount of bits dedicated to bits reserved for future international standardization (RES) purposes.

9. The method of claim 8, wherein said novel bit allocation comprises 4 bits dedicated to Justification Control (JC) bit purposes and 4 bits dedicated to bits reserved for future international standardization (RES) purposes.
